(19) United States
(12) Patent Application Publication
(10) Pub. No.: US 2015/0139334 A1
(43) Pub. Date: May 21, 2015

(54) METHOD FOR PARALLEL PROCESSING OF A VIDEO FRAME BASED ON WAVE-FRONT APPROACH

(71) Applicant: Samsung Electronics Co., Ltd., Suwon-si (KR)

(72) Inventors: Srinivas Reddy Eregala, Bangalore (IN); Nyeong-Kyu Kwon, Daejeon (KR)

(21) Appl. No.: 14/532,373

(22) Filed: Nov. 4, 2014

(30) Foreign Application Priority Data
Nov. 20, 2013 (KR) 10-2013-0141572

(51) Int. Cl. H04N 19/96; H04N 19/176; H04N 19/436

(52) U.S. Cl. CPC H04N 19/96; H04N 19/436; H04N 19/176
USPC 375/240.24

(57) ABSTRACT

A method for parallel processing of a video frame in accordance with principles of inventive concepts may include dividing the video frame into N tiles in a direction perpendicular to a raster scan direction; and sequentially encoding or decoding coding tree blocks included in each of the N tiles from a first row to an mth row according to the raster scan direction, wherein encoding or decoding of an Kth tile (K being a natural number more than 2 and less than N) starts at a point of time when encoding or decoding of coding tree blocks included in a first row of a (K−1)th tile is completed.

### CROSS-REFERENCE TO RELATED APPLICATIONS

A claim for priority under 35 U.S.C. §119 is made to Korean Patent Application No. 10-2013-0141572 filed Nov. 20, 2013, in the Korean Intellectual Property Office, the entire contents of which are hereby incorporated by reference.

### BACKGROUND

Inventive concepts relate to a method for parallel processing of a video frame, and more particularly, to a method of encoding or decoding video frames based on a multi-core processor.

With the advent of high quality video imagery, such as high definition (HD) and ultra-high definition (UHD) video, image sensors such as charge coupled devices (CCD) and CMOS image sensors have adapted to provide greater and greater resolution and, concomitantly, greater volumes of image data.

Although compression techniques, such as H.264/MPEG-4 AVC may be employed to cope with the massive volumes of data associated with high quality video, other, more efficient signal compression techniques are being explored

ISO/IEC Moving Picture Experts Group (MPEG) and ITU-T Video Coding Experts Group (VCEG) which developed the H.264/MPEG-4 AVC process established a Joint Collaborative Team on Video Coding (JCT-VC). High Efficiency Video Coding (HEVC) is a next-generation moving picture coding technique developed as a follow-on to the success of H.264/MPEG-4 AVC. HEVC is said to double the data compression ratio compared to H.264/MPEG-4 AVC at the same level of video quality. ITU announced that HEVC had received first stage approval (consent) in the ITU-T Alternative Approval Process (AAP).

The HEVC process uses hybrid coding, as previous video compression codecs did. However, the HEVC process uses a Coding Tree Block (CTB) without adopting a macro block used as a basic compression unit ranging from MPEG-2 to H.264/AVC. Unlike a macro block of 16×16 pixels, the size of the CTB is not fixed but variable, and images with various resolutions are coded more effectively.

A multi-core processor may be employed to advantage in the highly complex and data-intensive operation of a video codec, such as HEVC.

### SUMMARY

In exemplary embodiments in accordance with principles of inventive concepts a method for parallel processing of a video frame having m×n coding tree blocks includes dividing the video frame into N tiles in a direction perpendicular to a raster scan direction; and sequentially encoding or decoding coding tree blocks included in each of the N tiles from a first row to an mth row according to the raster scan direction, wherein encoding or decoding about an Kth tile (K being a natural number more than 2 and less than N) starts at a point of time when encoding or decoding about coding tree blocks included in a first row of a (K−1)th tile are completed.

In exemplary embodiments, the encoding or decoding about the Kth tile starts at the same time with a start of encoding or decoding about coding tree blocks included in a second row of the (K−1)th tile.

In exemplary embodiments, a coding tree block, finally encoded or decoded, from among coding tree blocks included in the first row of the (K−1)th tile is adjacent to coding tree blocks, first encoded or decoded, from among coding tree blocks included in the first row of the Kth tile.

In exemplary embodiments, neighboring information included in a coding tree block, belonging to the (K−1)th tile, from among coding tree blocks that respectively belong to the (K−1)th tile and the Kth tile and are adjacent to each other is transferred to a coding tree block belonging to the Kth tile through local memories connected among cores of a processor.

In exemplary embodiments, when the number of cores included in a processor is N, the tiles are encoded or decoded by the cores, respectively.

In exemplary embodiments, when the number (hereinafter, referred to as “C”) of cores included in a processor is less than N, the (C+1)th to Nth tiles are sequentially encoded or decoded by the first to Cth codes at a point of time when encoding or decoding about the first to Cth tiles is completed.

In exemplary embodiments, neighboring information included in a coding tree block, belonging to the (K−1)th tile, from among coding tree blocks that belong to the (K−1)th tile and the Kth tile and are adjacent to each other is transferred to a coding tree block belonging to the Kth tile through a memory connected in common to cores of a processor.

In exemplary embodiments, the memory is a volatile memory.

In exemplary embodiments, the sequentially encoding or decoding comprises performing a de-blocking filtering operation about the coding tree blocks included in the N tiles at boundaries among the plurality of tiles; and performing a sample adaptive offset filtering operation.

In exemplary embodiments, the sequentially encoding or decoding further comprises performing an adaptive loop filtering operation at boundaries among the plurality of tiles;

Another aspect of embodiments of the inventive concepts includes a method for parallel processing of a video frame having a plurality of coding tree blocks in parallel, the method comprising partitioning the video frames into M rows along a raster scan direction and into N columns along a direction perpendicular to the raster scan direction to generate M×N tiles; and sequentially encoding or decoding coding tree blocks included in each of the M×N tiles along the raster scan direction, wherein encoding or decoding of a [J:K] tile at a Jth row and a Kth column (J being a natural number less than M and K is a natural number less than N) starts at a point of time when encoding or decoding about coding tree blocks included in a first row of a [J:K−1] tile are completed.

In exemplary embodiments, the encoding or decoding of the [J:K] tile starts at the same time with a start of encoding or decoding about coding tree blocks included in a second row of the [J:K−1] tile.

In exemplary embodiments, a coding tree block, finally encoded or decoded, from among coding tree blocks included in the first row of the [J:K−1] tile is adjacent to coding tree blocks, first encoded or decoded, from among coding tree blocks included in the first row of the [J:K] tile.

In exemplary embodiments, when the number (M×N) of tiles is equal to the number of a plurality of cores in a processor, encoding or decoding of a [J+1:K] tile starts at a point of time when encoding or decoding about at least one of coding tree blocks included in a last row of the [J:K] tile is completed.

In exemplary embodiments, when the number (M×N) of tiles is more than the number of a plurality of cores in a processor, the plurality of tiles are allocated by the plurality of cores in a raster scan direction from a [1:1] tile so as to be encoded or decoded, and a core, which encodes or decodes a tile whose encoding or decoding is completed, sequentially encodes or decodes tiles not allocated along the raster scan direction, at a point of time when encoding or decoding about each of the allocated tiles is completed.

With the inventive concept, a video frame is divided into a plurality of specific areas (tiles), and a plurality of cores executes parallel processing about the plurality of tiles. Thus, encoding and decoding efficiencies are improved, and a processing speed is shortened.

In exemplary embodiments in accordance with principles of inventive concepts, a method of processing a video frame, includes vertically partitioning the frame into tiles including coding tree blocks; a plurality of cores processing tiles, with at least one tile being processed by a first core and another tile processed by a second core; and a second core commencing processing of a second tile before the first core completes processing of a first tile.

In exemplary embodiments in accordance with principles of inventive concepts adjacent bordering coding tree block neighboring information is pipelined to a core assigned to process an adjacent tile.

In exemplary embodiments in accordance with principles of inventive concepts, the processing is image encoding.

In exemplary embodiments in accordance with principles of inventive concepts, the processing is image decoding.

In exemplary embodiments in accordance with principles of inventive concepts, processing is carried out on coding tree blocks at an angle other than a horizontal or vertical direction of the image.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating an encoder encoding (or, coding) video frames based on HEVC;

FIG. 2 is a block diagram schematically illustrating an in-loop filter shown in FIG. 1;

FIG. 3 is a block diagram schematically illustrating a conventional decoder 200 decoding video data encoded based on HEVC;

FIG. 4 is a diagram showing loop filter dependency among tiles when video frames are processed in parallel;

FIG. 5 is a diagram showing a method for parallel processing of video frames, in accordance with principles of inventive concepts;

FIG. 6 is a diagram showing a parallel processing exemplary method in accordance with principles of inventive concepts according to lapse of time;

FIG. 7 is a diagram showing a parallel processing exemplary method in accordance with principles of inventive concepts;

FIG. 8 is a diagram showing an exemplary embodiment of a parallel processing method in accordance with principles of inventive concepts;

FIG. 9 is a diagram showing an exemplary embodiment of a parallel processing method in accordance with principles of inventive concepts;

FIG. 10 is a block diagram schematically illustrating an exemplary embodiment of a processor for implementing inter-core communication mechanism in a parallel processing method in accordance with principles of inventive concepts;

FIG. 11 is diagram schematically illustrating a system for transferring neighboring information in an exemplary method for parallel processing of video frames in accordance with principles of inventive concepts;

FIG. 12 is a block diagram schematically illustrating an exemplary embodiment of a multimedia device 1000 in accordance with principles of inventive concepts; and

FIG. 13 is a block diagram schematically illustrating an exemplary embodiment of a handheld terminal, or electronic device, in accordance with principles of inventive concepts.

### DETAILED DESCRIPTION

Below, a method for parallel processing of video frames will be used as an example to describe inventive concepts. Exemplary embodiments will be described in detail with reference to the accompanying drawings. Inventive concepts, however, may be embodied in various different forms, and should not be construed as being limited only to the illustrated exemplary embodiments. Rather, these embodiments are provided as examples so that this disclosure will be thorough and complete, and will fully convey inventive concepts to those skilled in the art. Accordingly, some known processes, elements, and techniques are not described with respect to some of the exemplary embodiments. Unless otherwise noted, like reference numerals denote like elements throughout the attached drawings and written description, and thus descriptions may not be repeated. In the drawings, the sizes and relative sizes of layers and regions may be exaggerated for clarity.

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough, and will convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, regions, layers and/or sections, these elements, components, regions, layers and/or sections should not be limited by these terms. These terms are only used to distinguish one element, component, region, layer or section from another region, layer or section. In this manner, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to illustrations that are schematic illustrations of idealized exemplary embodiments (and intermediate structures). As such, variations from the shapes of the illustrations as a result, for example, of manufacturing techniques and/or tolerances, are to be expected. In this manner, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. In this manner, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

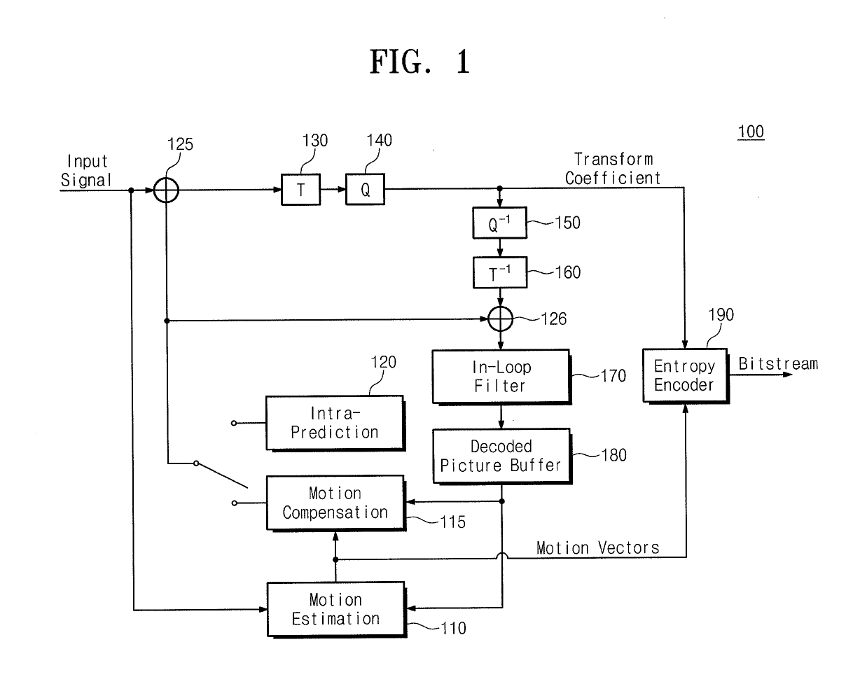

FIG. 1 is a block diagram schematically illustrating an encoder 100 encoding (or, coding) video frames based on HEVC. Such an encoder may be referred to herein as a “general” or “conventional” encoder, for example. Encoder 100 includes a motion estimation unit 110, a motion compensation unit 115, an intra-prediction unit 120, adders 125 and 126, a transformation unit 130, a quantization unit 140, an inverse quantization unit 150, an inverse transformation unit 160, an in-loop filter 170, a decoded picture buffer 180, and an entropy encoder 190.

Encoding of HEVC may be implemented as follows. To encode video data Input Signal, video frames are partitioned into a plurality of blocks (for example, a macro block MB or a coding tree block CTB) that are able to be independently completed. Partition may be executed by a core embedded in a Central Processing Unit (CPU) or by a core embedded in a Graphics Processing Unit (GPU), for example. Encoding may be accomplished by summing an intra-prediction based on adjacent blocks on the same frame as a current frame and an inter-prediction based on a block of a previous block and performing transformation and quantization of the summing result, for example.

The motion estimation unit 110 may compare the current frame and the previous frame for the inter-prediction. Based on the comparison result, the motion estimation unit 110 detects a block, being most similar to a block of the previous frame, from among blocks of the current frame. Based on the detection result, the motion estimation unit 110 generates motion vectors indicating a position relationship between a block of the current frame and the detected block of the previous frame. The motion compensation unit 115 acquires a prediction image (that is, an image corresponding to a difference between the current frame and the previous frame) detected through the motion estimation and sends it to the adders 125 and 126.

The intra-prediction unit 120 performs intra-prediction to search for a prediction image of a block of the current frame from blocks spatially adjacent to a block to be predicted. The block to be predicted and the adjacent blocks may be adjacent to one another on the same frame. The prediction block, related to a current block generated through the intra-prediction, is sent to the adders 125 and 126.

The adder 125 adds prediction blocks generated by the inter-prediction and the intra-prediction processes and generates a residual block corresponding to differences between the added prediction blocks and the current blocks.

The transformation unit 130 and the quantization unit 140 perform transformation and quantization of the residual block, thereby yielding a transform coefficient.

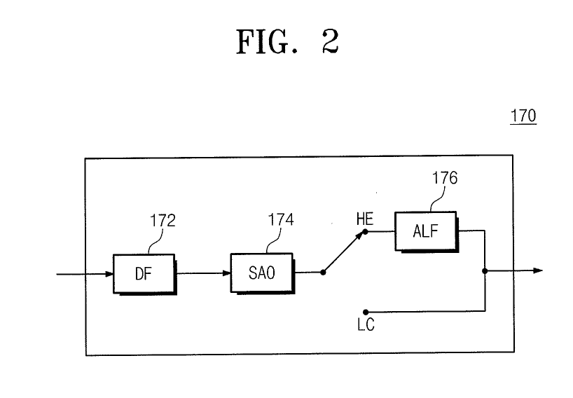

The inverse quantization unit 150 restores the transformed and quantized residual block to obtain blocks used for the above-described inter-prediction. The restored residual block is provided to the motion compensation unit 115 through the in-loop filter 170 and the decoded picture buffer 180. The in-loop filter 170 will be described in greater detail in the discussion related to FIG. 2.

The entropy encoder 190 outputs a bit stream Bitstream by performing entropy encoding of motion vectors generated from the motion estimation unit and the transform coefficient generated through the transformation and quantization. Lossless entropy encoding may be carried out by Huffman block encoding, for example.

FIG. 2 is a block diagram schematically illustrating an in-loop filter 170 such as is shown in FIG. 1. An HEVC in-loop filter 170 may include a de-blocking filter 172 and a Sample Adaptive Offset (SAO) filter 174. Applied to a video compression technique other than HEVC according to principles of inventive concepts, the in-loop filter 170 may further include a filtering operation using an adaptive offset filter 176. An in-loop filter complying with the conventional H.264/AVC standard may only have the de-blocking filter, but an in-loop filter complying with the H.265/HEVC standard may further include a sample adaptive offset filter to improve image quality and compression efficiency, for example. The de-blocking filter 172 eliminates a blocking artifact appearing at a block boundary through de-blocking filtering. The sample adaptive offset filter 174 or the adaptive offset filter 176 improves image quality through filtering. Filtering of the in-loop filter 170 may be performed during encoding or decoding.

The in-loop filtering may be executed in the order of de-blocking and sample adaptive offset under the HEVC standard. However, if in-loop filter includes the adaptive offset filter 176, when applied to a video compression technique other than HEVC in accordance with principles of inventive concepts, it may also include adaptive loop filtering under the condition of High Efficiency (HE). The in-loop filtering may be executed in the order of de-blocking and sample adaptive offset under the condition of Low Complexity (LC) except for the adaptive offset filtering.

The de-blocking filter 172 removes the blocking artifact due to transformation and quantization. Noise at a block boundary is removed because a restored image is processed by the block unit. De-blocking may be an operation of selectively performing low pass filtering of a boundary between blocks, for example.

The sample adaptive offset filter 174 calculates an offset of a current block. The sample adaptive offset filter 174 improves subjective image quality and encoding (or, compression) efficiency by making up for distortion between an original frame and a restored frame caused through encoding (for example, quantization) through an offset of a sample unit. In particular, distortion may be efficiently reduced by using an adaptive offset compensation method in which different offsets are applied to samples having different distortion levels. Unlike the de-blocking filter 172, a sample adaptive offset may improve the subjective image quality and peak signal to noise ratio (PSNR) by directly calculating a difference between an original frame and a restored frame.

Applied to a video compression technique other than HEVC in accordance with principles of inventive concepts, the in-loop filter 170 may further include the adaptive offset filter 176. The adaptive offset filter 176 may make up for loss of information due to encoding (for example, quantization). The adaptive offset filter 176 may be applied after adaptive offset is applied and may be applied only to High Efficiency (HE), for example.

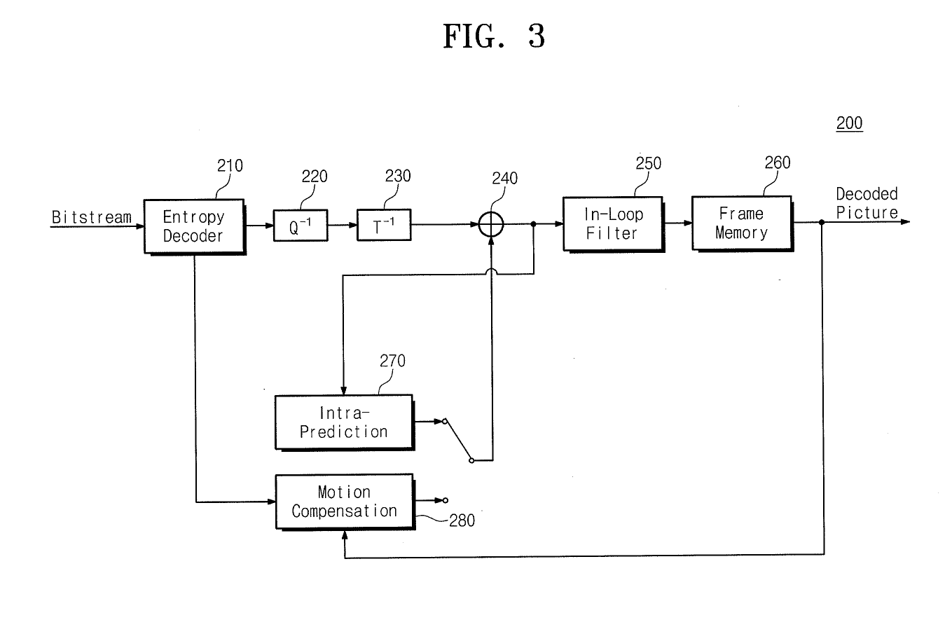

FIG. 3 is a block diagram schematically illustrating a conventional decoder 200 decoding video data encoded based on HEVC. Decoder 200 includes an entropy decoder 210, an inverse quantization unit 220, an inverse transformation unit 230, an adder 240, an in-loop filter 250, a frame memory 260, an intra-prediction unit 270, and a motion compensation unit 280. Because a detailed description of the operation of each component is as described with reference to FIGS. 1 and 2, a detailed description will not be repeated here.

The entropy decoder 210 performs lossless decoding on an input bit stream Bitstream. The lossless decoding may be performed by Huffman block decoding, arithmetic decoding, or variable length decoding, for example.

The inverse quantization unit 220 and the inverse transformation unit 230 recover an encoded bit stream through inverse quantization and inverse transformation. The recovered image data is compensated through the intra-prediction unit 270 and the motion compensation unit 280, and a compensated result is provided to the in-loop filter 250 for filtering. The in-loop filter 250, as illustrated in FIG. 2, may include a de-blocking filter DF, a sample adaptive offset filter SAO, and an adaptive offset filter ALF, for example.

The frame memory 260 may be a temporary buffer for transferring filtered data to the intra-prediction unit 270 and the motion compensation unit 280 for compensation of the filtered data. Image data may be output in the form of a decoded picture, or image, through the motion compensation unit 280, the adder 240, the in-loop filter 250, and the frame memory 260.

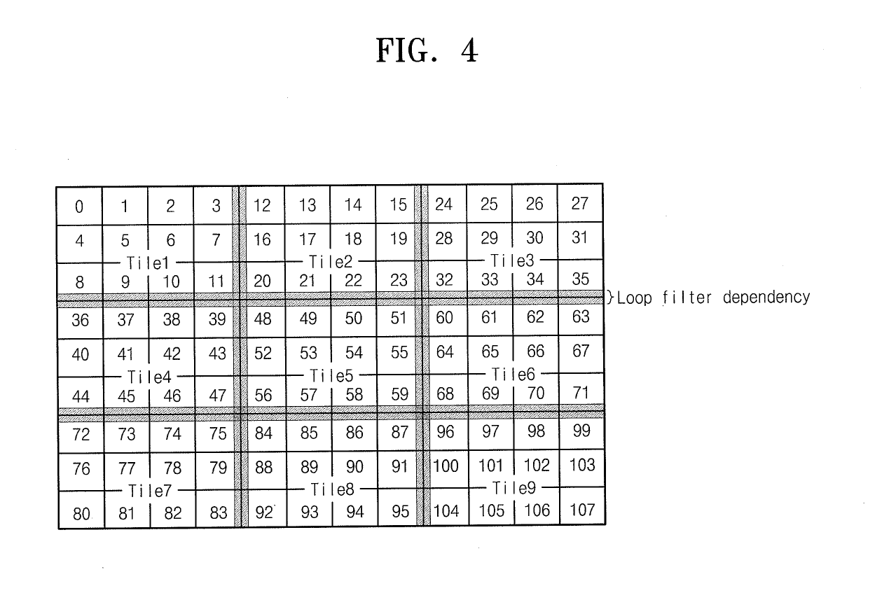

FIG. 4 is a diagram showing loop filter dependency among tiles when video frames are processed in parallel. A tile is adopted by HEVC and is one of the partitioned portions of a video frame capable of being independently decoded. Each tile has header information, is able to be encoded, and includes a plurality of coding tree blocks CTBs. An HEVC process uses hybrid coding like conventional video compression codecs, but it uses a coding tree block CTB without using a macro block (which was used as a basic block unit of compression ranging from MPEG-2 to H.264/AVC). Unlike a macro block of 16×16 pixels, the coding tree block CTB is not fixed but variable and, as a result, the coding tree block CTB may be more effective to encode various resolutions of images.

Raster scan coding refers to coding in which coding tree blocks are encoded or decoded according to a raster scan order. That is, raster scan coding means that if encoding and decoding is completed through transformation, quantization, inverse transformation, inverse quantization, and in particular, in-loop filtering executed at a tile boundary, an adjacent coding tree block is encoded or decoded according to the raster scan order.

A wave-front approach to coding refers to encoding or decoding is sequentially carried out according to a raster scan order with each row delayed by a constant time.

Although, generally, each tile may be independently processed (encoded/decoded), neighboring information (that is, information related to neighboring tiles) is required for use in in-loop filtering of adjacent bordering CTBs and, as a result, dependency among the ties may not be completely removed.

In the example of FIG. 4, the raster scan direction is from left-to-right. In a conventional wave-front approach, carried out from a coding tree block CTB0 of a tile 1, coding tree blocks CTB0, CTB1 . . . CTB11 of the tile 1 are sequentially processed. The wave-front approach of tile 2 is sequentially performed in the order of CTB12, CTB13 . . . CTB23. As previously described, although a tile could be individually processed (encoded/decoded) neighboring information is required for in-loop filtering of adjacent coding tile blocks on tile boundaries and, in this example, CTB3 of the tile 1 must be processed to perform in-loop filtering at the boundary between the tile 1 and the tile 2. Referring to FIGS. 1 and 3, in-loop filtering of an in-loop filter 240 is performed during decoding (although a frame buffer 260 exists, it is not used for filtering because it is a buffer for motion compensation) because a next CTB starts to be processed after processing of a CTB is completed. After tile 1 is processed, the wave-front approach of tile 2 is executed beginning with code tree block CTB12. In this approach tile 2 is processed only after tile 1 is completed because neighboring information for in-loop filtering with code tree block 12 CTB12 of tile 2 becomes available from the adjacent, bordering, code tree block 3 CTB3 of tile 1 only after tile 1 has been processed

Similarly, the other tile bordering tile 1, tile 4, is processed in the same manner as described above. The wave-front approach of tile 4 is executed in the order of CTB36, CTB37 . . . CTB47. As with the bordering coding tree blocks CTB3 and CTB12, CTB8 must be processed prior to processing of CTB36, and CTB9, CTB10, and CTB11 must be processed prior to processing of CTB37, CTB38, and CTB39, respectively. Although tiles are independently decoded, inter-tile dependency (that is, dependency at a boundary between tiles at in-loop filtering) generated in executing in-loop filtering may restrict the efficiency of parallel processing using a multi-processor in a conventional wave-front processing approach.

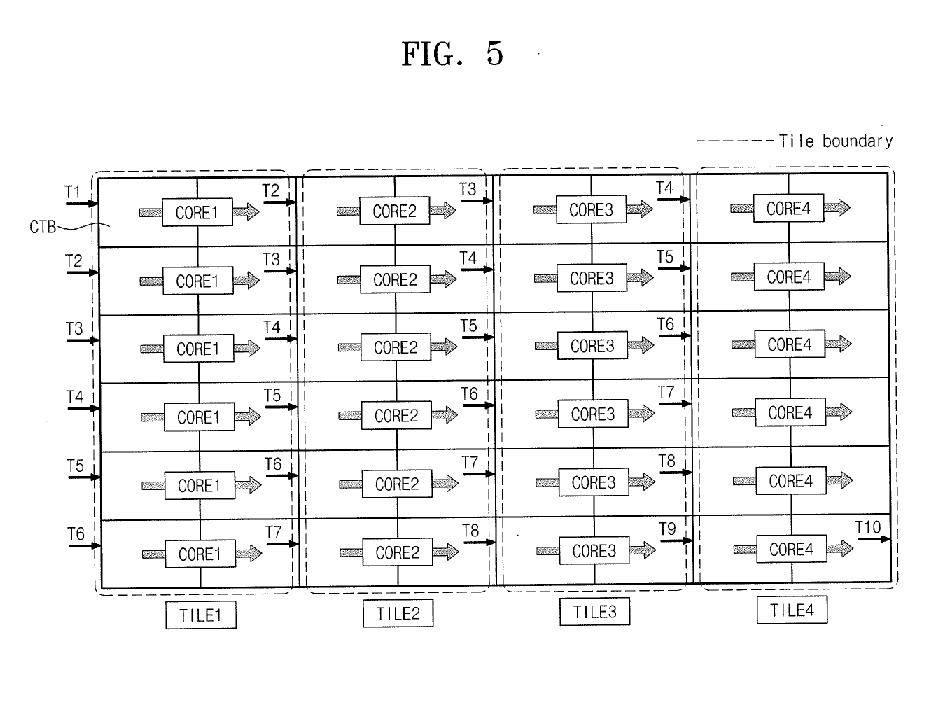

FIG. 5 is a diagram illustrating a method for parallel processing of video frames, in accordance with principles of inventive concepts in which coding tree block processing may be “pipelined” in order to more fully utilize the power of parallel processing using, for example, multiple processors or, more particularly, multiple processor cores.

In this exemplary embodiment in accordance with principles of inventive concepts a video frame is divided into four “vertical” tiles (that is, tiles that divide the video frame into horizontal segments, each extending from the top of the frame to the bottom of the frame) and each tile is divided into 6×2 CTBs. In this exemplary embodiment a video frame includes 6×8 CTBs. Below, “m×n point” may refer to a CTB position at the mth row and nth column of the video frame.

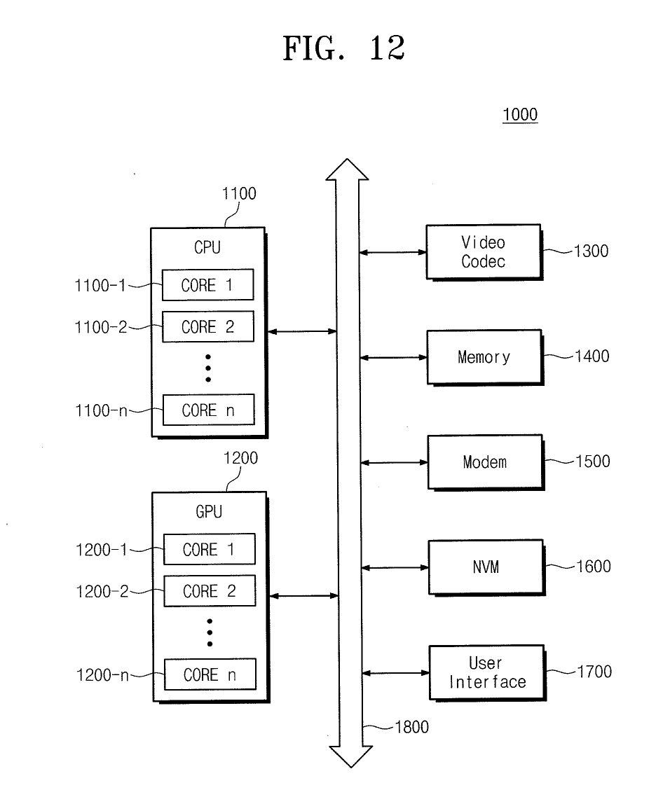

Encoding or decoding to be described in greater detail later may be executed by a codec circuit and a core embedded in a Graphics Processing Unit (GPU), for example. In embodiments in which a GPU is not provided or in an embodiment employing a moving picture format where a codec circuit is not provided, software for processing a corresponding format may be loaded on a graphics processing device for software processing. Alternatively, encoding or decoding may be executed in a software method through a central processing unit (refer to FIG. 12), for example.

With a conventional parallel processing method, encoding or decoding of a video frame shown in FIG. 5 would be sequentially performed according to a raster scan order from tile TILE1 to tile TILE4, with each tile completed, in order, before the next tile is processed. Coding tree block CTB corresponding to a 1×1 point in a first row of the tile 1 would be processed, then coding tree block CTB corresponding to a 1×2 point, then CTB 2×1, CTB 2×2, CTB 3×1, CTB 3×2, CTB 4×1, CTB 4×2, CTB 5×1, CTB 5×2, CTB 6×1 and, finally, CTB 6×2, would be processed. Only after all these coding tree blocks of tile 1 are processed would tile 2 be processed in a similar manner and, after tile 2, tile3 and tile 4 in like manner, to complete processing of the frame, after which a next frame may be processed (that is, encoded or decoded). ///In contrast, in a method for parallel processing of video frames in accordance with principles of inventive concepts, a video frame is divided by the number of processor cores that will be employed for the processing, and the cores execute the wave-front approach of each tile such that tiles are simultaneously processed in parallel, rather than the sequential, tile by tile, approach just described for a conventional process. The partition of the video frame may be executed by a CPU or a core embedded in a GPU, and a core processing video frames in parallel refers to a CPU or core embedded in the GPU. For example, assuming that the number of cores is 4, in exemplary embodiments in accordance with principles of inventive concepts a video frame is divided by 4 and four cores, CORE1 to CORE4, perform the wave-front approach of tiles. As previously noted, in exemplary embodiments in accordance with principles of inventive concepts, a frame is divided into vertical tiles (in some embodiments, each of the tiles extends from the top of the frame to the bottom of the frame). In accordance with principles of inventive concepts, processing of tiles and more particularly, of coding tree blocks, may be proceed at an angle other than horizontal or vertical with respect to the context of the image frame. That is, processing may proceed, for example, from the upper left corner of an image toward the lower right corner of the image, sweeping coding tree blocks, and engaging their associated processing cores, as neighboring information becomes available from processed coding tree blocks.

The label “T1” will be used to refer to a point in time when the wave-front approach of a current frame begins execution in accordance with principles of inventive concepts and to a time period associated with the processing (encoding/decoding) of a first pair of code tree blocks. At time T1, the core CORE1 commences sequential processing of coding tree blocks included in a first row of tile TILE1 according to a raster scan direction. Processing of the coding tree blocks (placed at a 1×1 point and at a 1×2 point) arranged in the first row of the tile TILE1 is completed at T2. When processing of the coding tree blocks arranged in the first row of the tile TILE1 is complete, the core CORE1 is ready to process coding tree blocks (located at a 2×1 point and at a 2×2 point) arranged in the second row of the tile TILE1, and the core CORE2 is ready to process (that is, perform encoding or decoding of) coding tree blocks (placed at a 1×3 point and at a 1×4 point) arranged in the first row of the tile TILE2. Such a progression in processing accommodates the fact that adjacent coding tree blocks lying on tile boundaries may include information necessary for processing coding tree blocks in a subsequent tile. For example, a coding tree block corresponding to a 1×2 point, which lies within tile 1, includes neighboring information (for example, a sample value or sample adaptive offset (SAO) information) necessary to process a coding tree block corresponding to a 1×3 point, which lies within subsequent tile, tile 2.

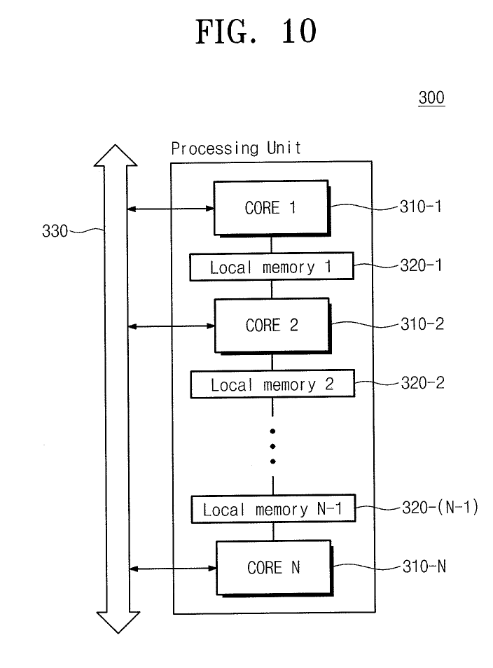

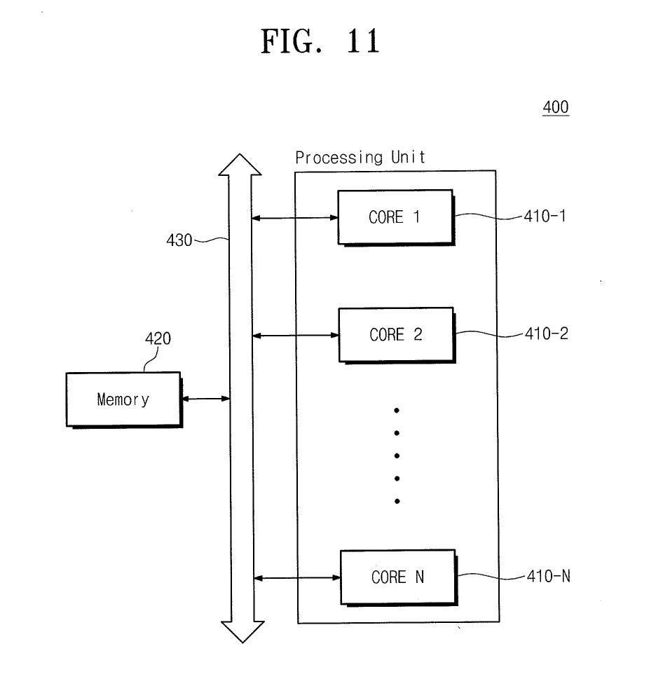

The neighboring information may be transferred to a bordering coding tree block (that is, an adjacent coding tree block lying on a tile boundary), or core associated therewith, through an inter-core communication mechanism. The inter-core communication mechanism may be implemented by providing local memories (for example, 320-1 to 320-(N−1) in FIG. 10) for transferring the neighboring information between cores. In exemplary embodiments in accordance with principles of inventive concepts, all local memories need not be disposed among cores. For example, three local memories may be disposed between the cores CORE1 and CORE2, between the cores CORE2 and CORE3, and between the cores CORE3 and CORE4. In exemplary embodiments, the local memory may be a volatile memory device such as a DRAM or an SRAM. Alternatively, rather than using an inter-core communication mechanism, the neighboring information may be transferred to an adjacent core through a memory (for example, 420 shown in FIG. 11) connected in common among cores. In exemplary embodiments, the memory may be a volatile memory device such as a DRAM or an SRAM.

At time T2, the core CORE1 processes coding tree blocks in the second row of its associated tile, tile 1. That is, in this exemplary embodiment CORE1 sequentially performs encoding or decoding of coding tree blocks (for example, placed at a 2×1 point and at a 2×2 point) included in a second row of the tile TILE1 according to the raster scan direction. Additionally, the second core, core CORE2 sequentially processes coding tree blocks in the first row of its associated tile, TILE2 (placed at a 1×3 point and at a 1×4 point) included in a first row of the tile TILE2. In this exemplary embodiment in accordance with principles of inventive concepts, processing (encoding or decoding) of TILE2 may commence as soon as processing of row 1 of TILE1 is completed; neighboring information from coding tree block 1λ2 is available for use in processing coding tree block 1×3 by CORE2 at this point. By pipelining processing in this manner (that is, commencing processing of an adjacent tile by another core as neighboring information from a coding tree block becomes available) a method and apparatus in accordance with principles of inventive concepts may accelerate processing and take fuller advantage of the parallel processing of image frames afforded by multiple cores.

Similarly, when encoding or decoding associated with coding tree blocks included in the second row of the tile TILE1 and in the first row of the tile TILE2 is completed at time T3, the core CORE1 is ready to encode or decode coding tree blocks (located at 3×1 and 3×2 points) included in a third row of the tile TILE1, the core CORE2 is ready to encode or decode coding tree blocks (placed at 2×3 and 2×4 points) included in a second row of the tile TILE2, and the core CORE3 is ready to encode or decode coding tree blocks (placed at 1×5 and 1×6 points) included in a first row of the tile TILE3. As previously indicated, such a progression in processing accommodates the fact that coding tree blocks may include information necessary for processing subsequent coding tree blocks. In accordance with principles of inventive concepts, a neighboring core may begin processing as soon as neighboring information is available from an adjacent coding tree block, rather than waiting for the entire antecedent tile to be completely processed, as in conventional approaches. For example, a coding tree block corresponding to a 2×2 point includes neighboring information needed to process a coding tree block corresponding to a 2×3 point and that a coding tree block corresponding to a 1×4 point includes neighboring information (for example, a sample value or sample adaptive offset information) needed to process a coding tree block corresponding to a 1×5 point.

The neighboring information may be transferred to a coding tree block of an adjacent tile through the inter-core communication mechanism or through a memory connected in common to a plurality of cores. A detailed description associated with the neighboring information is as described above, and will not be repeated here.

At time T3, the core CORE1 sequentially performs encoding or decoding of coding tree blocks (for example, placed at a 3×1 point and at a 3×2 point) included in a third row of the tile TILE1 according to the raster scan direction, the core CORE2 sequentially performs encoding or decoding of coding tree blocks (for example, placed at a 2×3 point and at a 2×4 point) included in a second row of the tile TILE2 according to the raster scan direction, and the core CORE3 sequentially performs encoding or decoding of coding tree blocks (for example, placed at a 1×5 point and at a 1×6 point) included in a first row of the tile TILE3 according to the raster scan direction. That is, coding tree blocks included in the tiles TILE1 to TILE3 are processed in parallel ranging from T3 to T4.

When encoding or decoding associated with coding tree blocks included in the third row of the tile TILE1, in the second row of the tile TILE2, and in the first row of the tile TILE3 is completed at T4, the core CORE1 is ready to encode or decode coding tree blocks (placed at 4×1 and 4×2 points) included in a fourth row of the tile TILE1, the core CORE2 is ready to encode or decode coding tree blocks (placed at 3×3 and 3×4 points) included in a third row of the tile TILE2, the core CORE5 is ready to encode or decode coding tree blocks (placed at 2×5 and 2×6 points) included in a second row of the tile TILE3, and the core CORE4 is ready to encode or decode coding tree blocks (placed at 1×7 and 1×8 points) included in a first row of the tile TILE4. As previously indicated, such a progression in processing accommodates the fact that coding tree blocks may include information necessary for processing subsequent coding tree blocks. For example, a coding tree block corresponding to a 3×2 point incudes neighboring information (for example, a sample value or sample adaptive offset (SAO) information) needed to process a coding tree block corresponding to a 3×3 point, that a coding tree block corresponding to a 2×4 point incudes neighboring information needed to process a coding tree block corresponding to a 2×5 point, and that a coding tree block corresponding to a 1×6 point incudes neighboring information needed to process a coding tree block corresponding to a 1×7 point.

The neighboring information may be transferred to a coding tree block of an adjacent tile through the inter-core communication mechanism or through a memory connected in common to a plurality of cores. Neighboring information has been described and the description thereof will not be repeated in detail here.

At time T4, the core CORE1 encodes or decodes coding tree blocks (placed at 4×1 and 4×2 points) included in the fourth row of the tile TILE1, the core CORE2 encodes or decodes coding tree blocks (placed at 3×3 and 3×4 points) included in the third row of the tile TILE2, the core CORE3 encodes or decodes coding tree blocks (placed at 2×5 and 2×6 points) included in the second row of the tile TILE3, and the core CORE4 encodes or decodes coding tree blocks (placed at 1×7 and 1×8 points) included in the first row of the tile TILE4. That is, coding tree blocks included in the tiles TILE1 to TILE4 are processed in parallel ranging from T4 to T5.

Afterwards, as time elapses, the cores CORE1 to CORE4 sequentially execute the wave-front approach of the tiles TILE1 to TILE4 according to the raster scan direction. At this time, the tiles TILE1 to TILE4 are processed in parallel.

When encoding or decoding of the tile TILE1 is completed at time T7, coding tree blocks included in a sixth row of the tile TILE2, in a fifth row of the tile TILE3, and in a fourth row of the tile TILE4 are processed in parallel ranging from timeT7 to time T8.

Afterwards, coding tree blocks included in a sixth row of the tile TILE3 and in a fifth row of the tile TILE4 are processed in parallel ranging from time T8 to time T9. The wave-front approach of the tile TILE4 starts at time T9. Processing of the current frame is completed when encoding or decoding of the tile TILE4 is completed at time T10. Then, a next frame may be processed. That is, the time when a tile receiving neighboring information from an adjacent tile is processed may be delayed by the time when the wave-front approach of coding tree blocks included in a row of a tile is executed.

If filtering were performed according to a conventional parallel processing method, processing a frame would require six times time T6 required to complete processing of a single tile (this assumes, of course, that the image frame is divided into six tiles, which it would not be, conventionally). In contrast, if tiles are processed in parallel in accordance with principles of inventive concepts, only a time of about T10 to T1 is required to process a frame. More generally, if Tr represents the time required to process a single row of coding tree blocks within a tile and an image is partitioned into m×n coding tree block row partitions (for example, CTB 1×1 and 1×2 represent the first coding tree block row partition of tile 1, processed by CORE1), a method and apparatus in accordance with principles of inventive concepts requires only (m+n)Tr to process an image. On the other hand, a conventional approach would require (mXn)Tr to process an image. That is, employing a method in accordance with principles of inventive concepts may significantly reduce the time required to process an image frame. Encoding and decoding complicated, computation intensive, data may also be executed efficiently in accordance with principles of inventive concepts.

With a parallel processing method in accordance with principles of inventive concepts, a video frame is divided by a multiple of the number of cores or is divided to be less than or more than the number of cores. If the number of partitioned tiles is less than the number of cores, a core not to participate in parallel processing, a “spare core,” exists, and the spare core may be under-utilized. For example, assuming that the number of cores is 4, a video frame is divided into eight tiles or into ten tiles. If the video frame is divided into eight tiles, a first set of four tiles are processed by four cores, then the remaining set of four tiles are processed by the four cores and, through this sequential parallel processing, encoding/decoding of a frame may be carried out. Similarly, if the video frame is divided into ten tiles, four tiles are processed by four cores, then, four tiles are processed by the four cores, and then the remaining two tiles are processed by two cores, thereby encoding/decoding a complete frame.

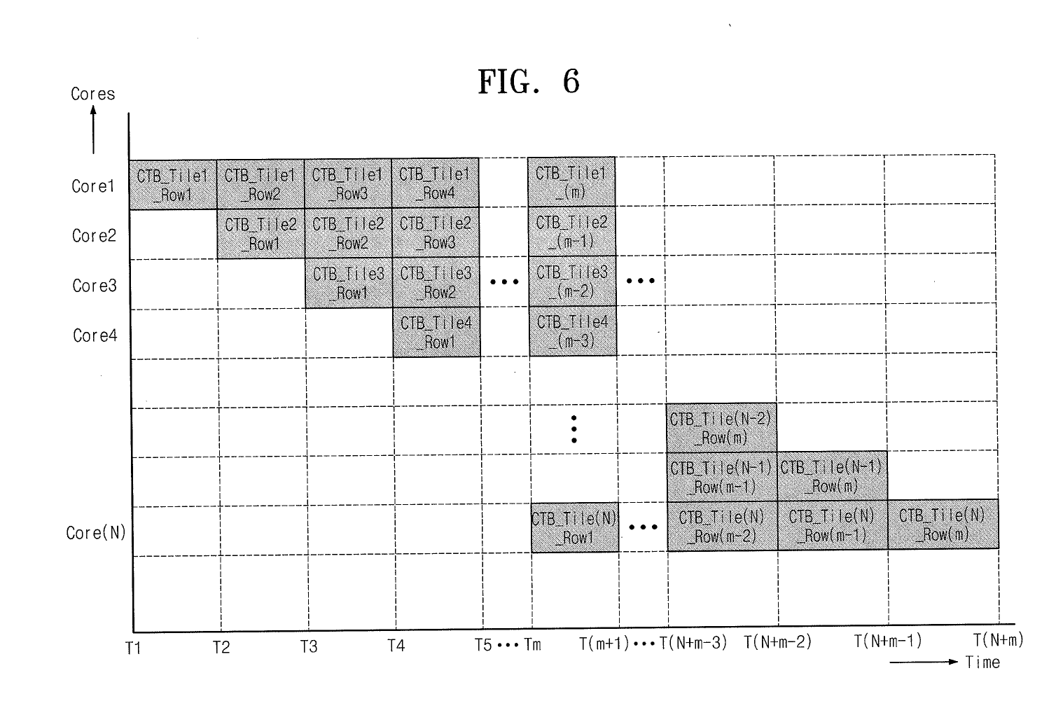

FIG. 6 is a timing diagram showing a parallel processing exemplary method in accordance with principles of inventive concepts. Tiles are processed in parallel according to wave-front approach with a time lag, also referred to herein as a pipelined, or parallel pipelined process.

Referring to FIG. 6, in this exemplary embodiment the number of cores of a processor to execute wave-front encoding/decoding of a frame in accordance with principles of inventive concepts is 4. Also, it is assumed that a video frame is formed of m rows of coding tree blocks. With this assumption, a current frame is divided into N tiles according to the number of cores of a processor, and cores CORE1 to COREN process the N tiles in parallel. It is assumed that the wave-front processing of a current video frame is executed at time T1.

At time T1, the core CORE1 encodes or decodes coding tree blocks included in a first row of the tile TILE1. When encoding or decoding of the coding tree blocks included in the first row of the tile TILE1 is completed, or completed, at time T2, the core CORE1 is ready to perform encoding or decoding of a second row of the tile TILE1, and the core CORE2 is ready to perform encoding or decoding of a first row of the tile TILE2.

At time T2, the core CORE1 encodes or decodes coding tree blocks included in a second row of the tile TILE1 according to a raster scan direction, and the core CORE2 encodes or decodes coding tree blocks included in a first row of the tile TILE2 according to the raster scan direction. That is, the second row of the tile TILE1 and the first row of the tile TILE2 are processed in parallel. At this time, neighboring information stored in a coding tree block, belonging to the tile TILE1, from among coding tree blocks existing at a portion where the first row of the tile TILE1 and the first row of the tile TILE2 are adjacent may be transferred to an adjacent coding tree block belonging to the tile TILE2 by inter-core communication mechanism. That is, neighboring information from a coding tree block within TILE1 on the boarder of TILE1 and TILE2 may be transferred via inter-core communication to a coding tree block (or, more particularly, to a core processing the coding tree block) within TILE2 that shares the border between TILE1 and TILE2.

At time T3, the core CORE1 encodes or decodes coding tree blocks included in a third row of the tile TILE1 according to the raster scan direction, the core CORE2 encodes or decodes coding tree blocks included in a second row of the tile TILE2 according to the raster scan direction, and the core CORE3 encodes or decodes coding tree blocks included in a first row of the tile TILE3 according to the raster scan direction. That is, the third row of the tile TILE1, the second row of the tile TILE2, and the first row of the tile TILE3 are processed in parallel. At this time, neighboring information stored in a coding tree block, belonging to the tile TILE1, from among coding tree blocks existing at a portion where the second row of the tile TILE1 and the second row of the tile TILE2 are adjacent may be transferred to an adjacent coding tree block belonging to the tile TILE2 by the inter-core communication mechanism and neighboring information between coding tree blocks in TILE2 and TILE3 (blocks existing at a portion where the first row of the tile TILE2 and the first row of the tile TILE3 are adjacent) may be similarly transferred.

With encoding or decoding sequentially performed, processing of the tile 1 is completed at T(m+1) (where T represents a time period required to process a tile row). As parallel processing is carried out, a plurality of tiles may be sequentially processed in parallel and when processing of tile TILEN is completed at T(N+m), all encoding or decoding of a current frame is completed.

If filtering were performed according to a general, that is, conventional, wave-front approach, processing a frame would require N time periods Tm (where “Tm” is the time required to process an entire tile) may be completed when the wave-front approach is executed during N times a time Tm taken to complete the wave-front approach of a tile. In case of the inventive concept, since a time of about T(N+m−1) is required, a processing time may be shortened. Thus, it is possible to efficiently process complicated data necessitating a great deal of computation. That is, as previously described, if Tr represents the time required to process a single row of coding tree blocks within a tile and an image is partitioned into mXn coding tree block row partitions (for example, CTB 1×1 and 1×2 represent the first coding tree block row partition of tile 1, processed by CORE1), a method and apparatus in accordance with principles of inventive concepts requires only (m+n)Tr to process an image. On the other hand, a conventional approach would require (mXn)Tr to process an image.

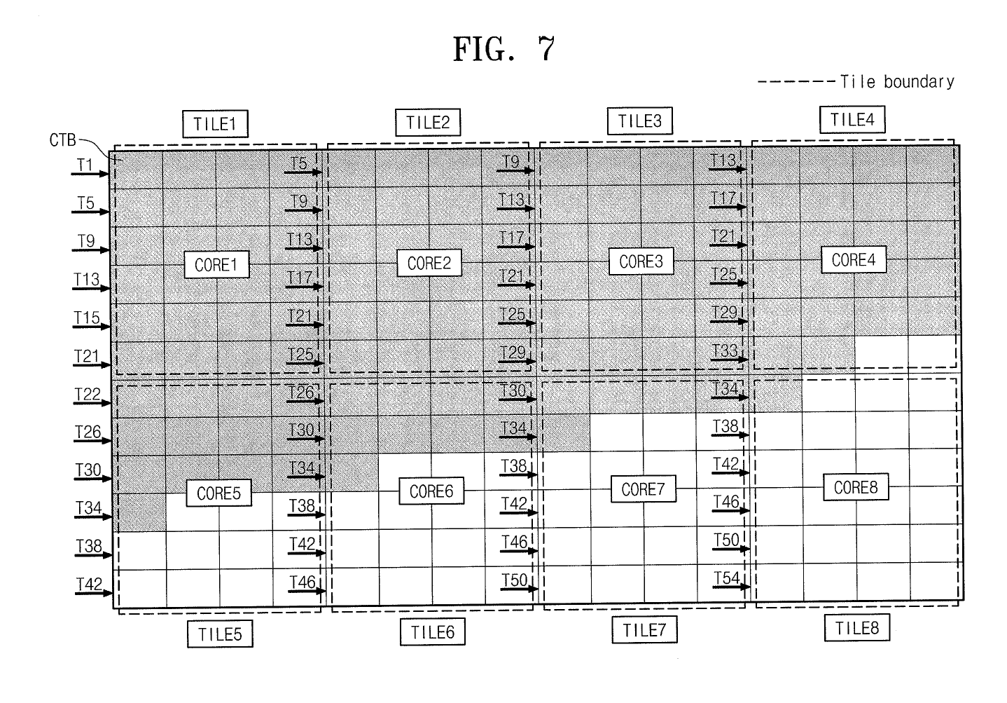

FIG. 7 is a diagram showing an exemplary embodiment of a parallel processing method in accordance with principles of inventive concepts. In FIG. 7, a darkly shaded coding tree block indicates a coding tree block where encoding or decoding is completed. Referring to FIG. 7, a video frame is divided not just along a direction perpendicular (that is, a vertical direction in FIG. 7) to a raster scan direction but along both the raster scan direction (that is, a horizontal direction in FIG. 7) and a direction perpendicular to the raster scan direction.

Referring to FIG. 7, the number of processors is 8, and a video frame is divided into eight tiles of 2 rows and 4 columns for parallel processing. The cores CORE1 to CORE8 are respectively allocated to the tiles TILE1 to TILE8 for encoding or decoding. As described above, in HEVC-based data, a frame is not divided into macro blocks having the same pixel size, but it is divided into coding tree blocks that are variable in size according to the amount of data, complexity, and the like. As a result, a frame may be partitioned in various ways to produce independently processed tiles, according to the amount of data in a coding tree block and its.

In this exemplary embodiment in accordance with principles of inventive concepts, parallel processing of a current frame begins execution at time T1. At time T1, a core CORE1 sequentially encodes or decodes coding tree blocks CTBs included in a first row of a first tile TILE1 according to a raster scan direction. Encoding or decoding of coding tree blocks (places at 1×1, 1×2, 1×3, and 1×4 points) arranged in the first row of the tile TILE1 is completed at time T5. When the encoding or decoding of coding tree blocks arranged in the first row of the tile TILE1 is completed, the core CORE1 is ready to encode or decode coding tree blocks (places at 2×1, 2×2, 2×3, and 2×4 points) arranged in the second row of the tile TILE1, and a core CORE2 is ready to encode or decode coding tree blocks (places at 1×5, 1×6, 1×7, and 1×8 points) arranged in the first row of the tile TILE2. CORE2 is able to begin processing TILE2 because coding tree block at the 1×4 has been processed and it includes neighboring information (for example, a pixel value and/or sample adaptive offset (SAO) information) necessary to process a coding tree block at the 1×5 point.

When encoding or decoding of the coding tree blocks included in the first row of the tile TILE1 is completed, at T5, the core CORE1 and the core CORE2 sequentially encode or decode coding tree blocks included in a second row of the tile TILE1 and coding tree blocks included in a first row of the tile TILE2. That is, the coding tree blocks included in the second row of the tile TILE1 and the coding tree blocks included in the first row of the tile TILE2 are processed in parallel. Neighboring information included in a coding tree block (placed at a 1×4 point), belonging to the tile TILE1, from among coding tree blocks arranged at a portion where the tiles TILE1 and TILE2 are adjacent to each other may be transferred to a coding tree block, or core processing the coding tree block (placed at a 1×5 point), belonging to the tile TILE2 through the inter-core communication mechanism. For example, the inter-core communication mechanism may be implemented by providing local memories (for example, 320-1 to 320-(N−1) in FIG. 10) disposed among a plurality of cores. In exemplary embodiments, the local memory may be a volatile memory device such as a DRAM or an SRAM. Alternatively, unlike the inter-core communication mechanism, the neighboring information may be transferred to an adjacent core through a memory (for example, 420 shown in FIG. 11) connected in common among cores. In exemplary embodiments, the memory may be a volatile memory device such as a DRAM or an SRAM.

When encoding or decoding of the coding tree blocks included in the second row of the tile TILE1 is completed, at time T9, the core CORE1 sequentially encodes or decodes coding tree blocks included in a third row of the tile TILE1 according to a raster scan direction, the core CORE2 sequentially encodes or decodes coding tree blocks included in a second row of the tile TILE2 according to the raster scan direction, and the core CORE3 sequentially encodes or decodes coding tree blocks included in a first row of the tile TILE3 according to the raster scan direction.

When parallel processing of a first coding tree block (that is, a coding tree block placed at a 6×1 point) included in the last row of the tile TILE1 is completed at time T22 with time, the core CORE5 may be ready to encode or decode a tile TILE5. The reason is that if a coding tree block placed at the 6×1 point is encoded or decoded in spite of dependency between tiles, a coding tree block placed at a 7×1 point is set to a state where it is ready to be encoded or decoded. Thus, encoding or decoding of the coding tree block placed at the 7×1 point commences with the same time when encoding or decoding of the coding tree block placed at the 6×1 point is completed. Similarly, encoding or decoding of a coding tree block of the tile TILE6 placed at the 7×5 point commences with the same time when encoding or decoding of a coding tree block of the tile TILE2 placed at a 6×5 point is completed. Coding tree blocks placed at 7×9 and 7×13 points may be the same. Thus, a processing speed may be further improved by performing partition in the raster scan direction (for example, a horizontal direction in FIG. 7).

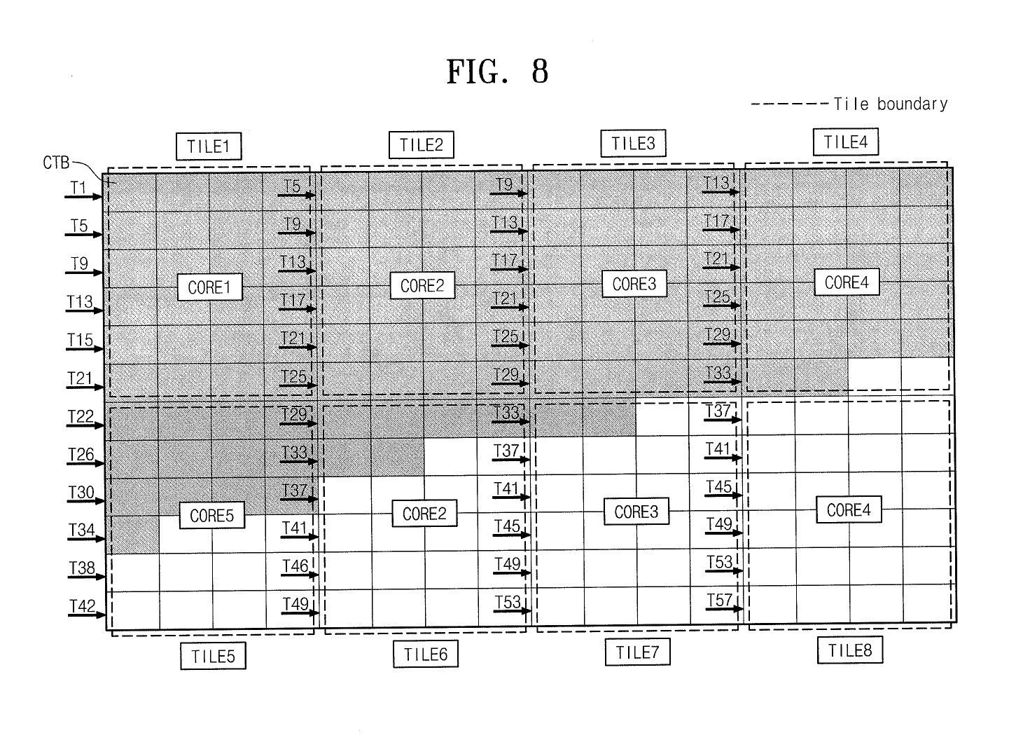

FIG. 8 is a diagram showing an exemplary embodiment of parallel processing method in accordance with principles of inventive concepts. In this exemplary embodiment, it is assumed that the number of cores is 5 and that the current frame is divided into eight tiles.

Similar to the above description, cores CORE1 to CORE4 encode or decode tiles TILE1 to TILE4, respectively. When encoding or decoding of a coding tree block placed at a 6×1 point is completed at time T22, the core CORE5 encodes or decodes a coding tree block placed at a 7×1 point.

If the number of cores is less than the number of tiles partitioned, processing (encode or decode) a coding tree block placed at a 7×5 point may not commence even though encoding or decoding of a coding tree block placed at a 6×5 point is completed. As the core CORE2 performs encoding or decoding of the tile TILE2, encoding or decoding of the tile TILE6 may be executed after all processing of the tile TILE2 is completed at time T29. The tiles TILE7 and TILE8 may be the same.

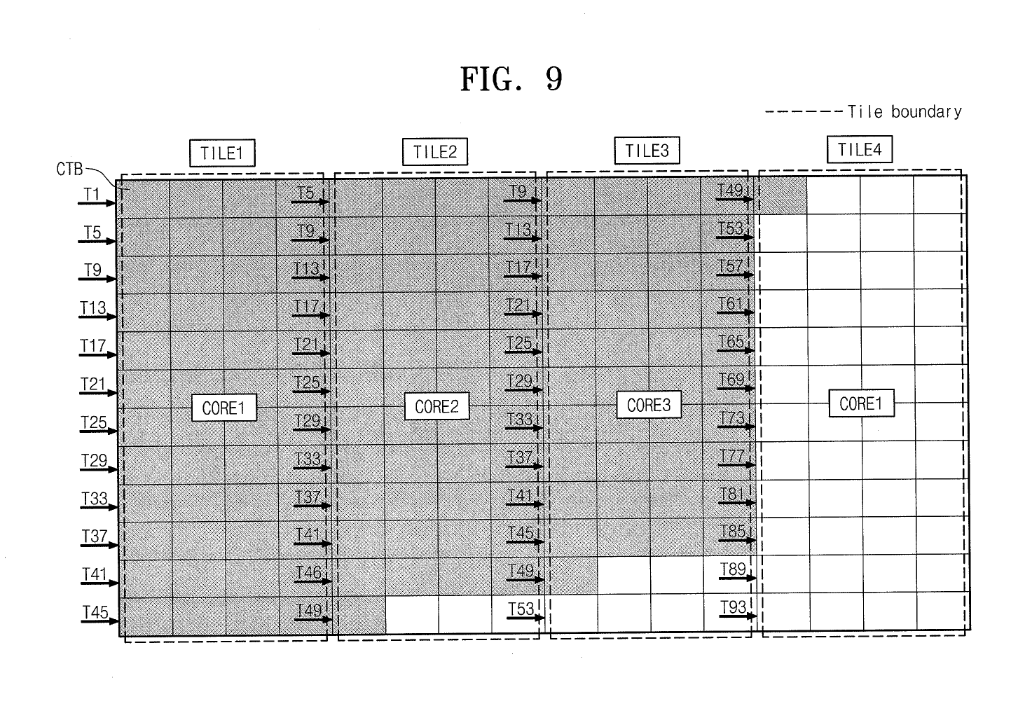

FIG. 9 is a diagram showing an exemplary embodiment of a parallel processing method in accordance with principles of inventive concepts. It is assumed that the number of cores is 3. Also, it is assumed that a current frame is divided into four tiles, only in a direction perpendicular to a raster scan direction.

As with the above description, at time T5, encoding or decoding of a coding tree block placed at a 1×5 point and a coding tree block placed at a 2×1 point may commence. At time T9, encoding or decoding of a coding tree block placed at a 1×9 point and a coding tree block placed at a 2×5 point may commence.

However, encoding or decoding of a coding tree block placed at a 1×13 point may not be performed at time T13 because the cores CORE1 to CORE3 are processing the tiles TILE1 to TILE3. For this reason, the tile TILE4 may be at last encoded or decoded at time T49, a time when all encoding or decoding of the tile TILE1 is completed.

FIG. 10 is a block diagram schematically illustrating a processor for implementing inter-core communication mechanism in a parallel processing method in accordance with principles of inventive concepts. A processing unit may mean a Central Processing Unit (CPU) or a Graphics Processing Unit (GPU). In the event that the GPU and a codec circuit are prepared, the processing unit may mean the GPU. On the other hand, if the GPU is not prepared, encoding or decoding of the CPU may mean software processing. The processing unit includes a plurality of codes 310-1 to 310-N and a plurality of local memories 320-1 to 320-(N−1). Inter-core communication mechanism may be implemented through the local memories 320-1 to 320-(N−1). It is unnecessary to dispose local memories among a plurality of cores. The local memories may be disposed among cores where neighboring information is transferred. For example, (N−1) local memories may be disposed between a core CORE1 and a core CORE2, between the core CORE2 and a core CORE3 . . . between a core CORE(N−2) and a core CORE(N−1). In exemplary embodiments, the local memory may be a volatile memory such as a DRAM or an SRAM. The processor exchanges data with other devices through a system bus 330.

FIG. 11 is diagram schematically illustrating a system 300 for transferring neighboring information in a method for parallel processing of video frames, according to another embodiment of the inventive concept. A system 300 transfers neighboring information and includes a processing unit, a memory 420, and a system bus 430. The neighboring information may be transferred to an adjacent core through the memory 420 that is connected in common among cores 410-1 to 410-N, not inter-core communication mechanism. In exemplary embodiments, the memory 420 may be a volatile memory device such as a DRAM, an SRAM, and the like. The processing unit may exchange data with other devices through the system bus 430.

FIG. 12 is a block diagram schematically illustrating a multimedia device 1000 in accordance with principles of inventive concepts. Multimedia device 1000 has a Central Processing Unit (CPU) 1100, a Graphics Processing Unit (GPU) 1200, a video codec 1300, a memory 1400, a modem 1500, a nonvolatile memory device 1600, a user interface 1700, and/or a system bus 1800. The CPU 1100 includes a plurality of cores, each of which executes an overall task of each component of the multimedia device 1000. In FIG. 12, there is illustrated an example where the multimedia device 1000 has both the GPU 1200 and the video codec 1300. If the multimedia device 1000 does not have both the GPU 1200 and the video codec 1300, the CPU 1100 may execute a parallel processing operation described in the specification in software.

The GPU 1200 and the video codec 1300 may execute a task associated with processing of images. A plurality of cores included in the GPU 1200 divides a video frame into a plurality of tiles in accordance with principles of inventive concepts and processes the tiles in parallel.

The memory 1400 communicates with the CPU 1100. The memory 1400 may be a working (or, a main) memory of the CPU 1100 or the multimedia device 100. The memory 1400 may include a volatile memory such as an SRAM, a DRAM, a synchronous DRAM, and the like or a nonvolatile memory such as a phase-change RAM, a magnetic RAM, a resistive RAM, a ferroelectric RAM, and the like.

The modem 1500 communicates with an external device according to a control of the CPU 1100. For example, the modem 1500 executes wireless or wire communications with the external device. The modem 1500 may communicate with external devices based on at least one of wireless communication manners such as LTE (Long Term Evolution), WiMax, GSM (Global System for Mobile communication), CDMA (Code Division Multiple Access), Bluetooth, NFC (Near Field Communication), WiFi, RFID (Radio Frequency IDentification), and the like or wire communication manners such as USB (Universal Serial Bus), SATA (Serial AT Attachment), SCSI (Small Computer Small Interface), Firewire, PCI (Peripheral Component Interconnection), and the like.

The nonvolatile memory device 1600 stores long-term data of the multimedia device 1000. The nonvolatile memory device 1600 may include a hard disk drive or a nonvolatile memory such as a flash memory, a phase-change RAM, a magnetic RAM, a resistive RAM, a ferroelectric RAM, and the like.

The user interface 1700 communicates with a user according to a control of the CPU 1100. For example, the user interface 1700 may include user input interfaces such as a keyboard, a button, a keypad, a touch screen, a touch panel, a touch ball, a camera, a microphone, a Gyroscope sensor, a vibration sensor, and the like. The user interface 1700 may further comprise user output interfaces such as an LCD (Liquid Crystal Display), an OLED (Organic Light Emitting Diode) display device, an AMOLED (Active Matrix OLED) display device, an LED, a speaker, a motor, and the like.

In exemplary embodiments, the user interface 1700 may include an image capture device such as an image sensor and an image display device such as LCD and AMOLED. Also, the user interface 1700 may only include an image display device such as LCD and AMOLED without including an image capture device such as an image sensor.

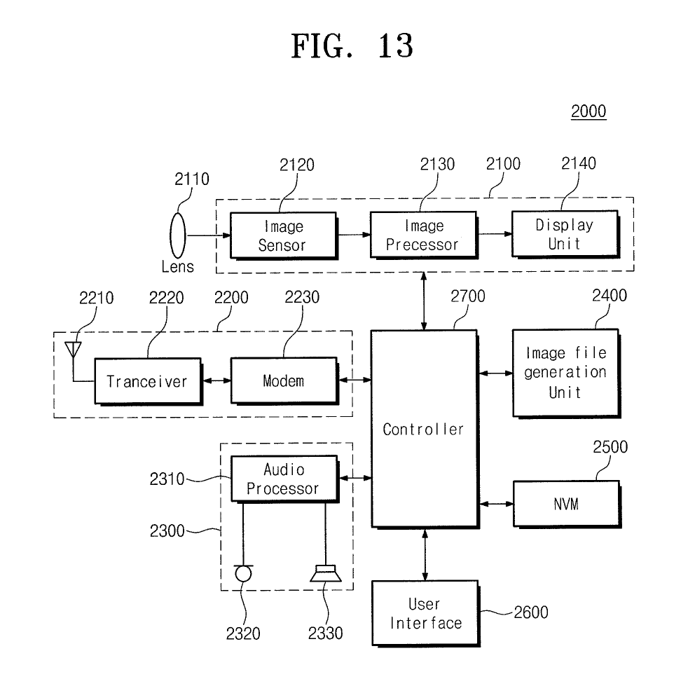

FIG. 13 is a block diagram schematically illustrating a handheld device in accordance with principles of inventive concepts. The handheld device may be a smartphone, PDA, or a tablet or notebook computer, for example. Referring to FIG. 13, a handheld device 2000 in accordance with principles of inventive concepts includes an image processing unit 2100, an RF transmission and reception unit 2200, an audio processing unit 2300, an image file generation unit 2400, a nonvolatile memory device 2500, a user interface 2600, and a controller 2700.

The image processing unit 2100 has a lens 2110, an image sensor 2120, an image processor 2130, and a display unit 2140. The RF transmission and reception unit 2200 includes an antenna 2210, a transceiver 2220, and a modem 2230. The audio processing unit 2300 has an audio processor 2310, a microphone 2320, and a speaker 2330.

The controller 2700 may include a CPU, a GPU, and a codec circuit that are driven in accordance with principles of inventive concepts. A method in which the CPU, GPU, or codec circuit processes video frames in parallel may be the same as described above; therefore, its detailed description will not be repeated here.

A controller 2700 may be packaged according to any of a variety of different packaging technologies. Examples of such packaging technologies include PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

While inventive concepts have been described with reference to exemplary embodiments, it will be apparent to those skilled in the art that various changes and modifications may be made without departing from the spirit and scope of inventive concepts. Therefore, it should be understood that the above embodiments are not limiting, but illustrative.

What is claimed is:

1. A method for parallel processing of a video frame having m×n coding tree blocks, the method comprising:
dividing the video frame into N tiles in a direction perpendicular to a raster scan direction; and
sequentially encoding or decoding coding tree blocks included in each of the N tiles from a first row to an mth row according to the raster scan direction,
wherein encoding or decoding of a Kth tile (K being a natural number more than 2 and less than N) starts at a point of time when encoding or decoding of coding tree blocks included in a first row of a (K−1)th tile are completed.

2. The method of claim 1, wherein the encoding or decoding of the Kth tile starts at the same time with a start of encoding or decoding of coding tree blocks included in a second row of the (K−1)th tile.

3. The method of claim 2, wherein a coding tree block, completely encoded or decoded, from among coding tree blocks included in the first row of the (K−1)th tile is adjacent to coding tree blocks, first encoded or decoded, from among coding tree blocks included in the first row of the Kth tile.

4. The method of claim 3, wherein neighboring information included in a coding tree block, belonging to the (K−1)th tile, from among coding tree blocks that respectively belong to the (K−1)th tile and the Kth tile are adjacent to each other is transferred to a coding tree block belonging to the Kth tile through local memories connected among cores of a processor.

5. The method of claim 3, wherein when the number of cores included in a processor is N, the tiles are encoded or decoded by the cores, respectively.

6. The method of claim 3, wherein when the number (hereinafter, referred to as “C”) of cores included in a processor is less than N, the (C+1)th to Nth tiles are sequentially encoded or decoded by the first to Cth cores at a point of time when encoding or decoding of the first to Cth tiles is respectively completed.

7. The method of claim 3, wherein neighboring information included in a coding tree block, belonging to the (K−1)th tile, from among coding tree blocks that respectively belong to the (K−1)th tile and the Kth tile are adjacent to each other is transferred to a coding tree block belonging to the Kth tile through a memory connected in common to cores of a processor.

8. The method of claim 7, wherein the memory is a volatile memory.

9. The method of claim 1, wherein the sequentially encoding or decoding comprises:
performing a de-blocking filtering operation of the coding tree blocks included in the N tiles at boundaries among the plurality of tiles; and
performing a sample adaptive offset filtering operation.

10. The method of claim 9, wherein the sequentially encoding or decoding further comprises:
performing an adaptive loop filtering operation at boundaries among the plurality of tiles;

11. A method for parallel processing of a video frame having a plurality of coding tree blocks, the method comprising:
partitioning the video frames into M rows along a raster scan direction and into N columns along a direction perpendicular to the raster scan direction to generate M×N tiles; and
sequentially encoding or decoding coding tree blocks included in each of the M×N tiles along the raster scan direction,
wherein encoding or decoding of a [J:K] tile at a Jth row and a Kth column (J being a natural number less than M and K is a natural number less than N) starts at a point of time when encoding or decoding of coding tree blocks included in a first row of a [J:K−1] tile are completed.

12. The method of claim 11, wherein the encoding or decoding of the [J:K] tile starts at the same time with a start of encoding or decoding of coding tree blocks included in a second row of the [J:K−1] tile.

13. The method of claim 12, wherein a coding tree block, finally encoded or decoded, from among coding tree blocks included in the first row of the [J:K−1] tile is adjacent to coding tree blocks, first encoded or decoded, from among coding tree blocks included in the first row of the [J:K] tile.

14. The method of claim 13, wherein when the number (M×N) of tiles is equal to the number of a plurality of cores in a processor, encoding or decoding of a [J+1:K] tile starts at a point of time when encoding or decoding of at least one of coding tree blocks included in a last row of the [J:K] tile is completed.

15. The method of claim 13, wherein when the number (M×N) of tiles is more than the number of a plurality of cores in a processor, the plurality of tiles are allocated by the plurality of cores in a raster scan direction from a [1:1] tile so as to be encoded or decoded, and wherein
a core, which encodes or decodes a tile whose encoding or decoding is completed, sequentially encodes or decodes tiles not allocated along the raster scan direction, at a point of time when encoding or decoding of each of the allocated tiles is completed.

16. A method of processing a video frame, comprising: vertically partitioning the frame into tiles including coding tree blocks;
a plurality of cores processing the tiles, with at least one tile being processed by a first core and another tile being processed by a second core; and
the second core commencing processing of a second tile before the first core completes processing of a first tile.

17. The method of claim 16, wherein adjacent bordering coding tree block neighboring information is pipelined to a core assigned to process an adjacent tile.

18. The method of claim 17, wherein the processing of the second tile commences after the processing of a first row of coding tree blocks included in the first tile is completed.

19. The method of claim 16, wherein the processing is image encoding or image decoding.

20. The method of claim 16, wherein processing is carried out on coding tree blocks at an angle other than a horizontal or vertical direction of the image.
